(19) United States
(12) Patent Application Publication
(10) Pub. No.: US 2026/0118628 A1
(43) Pub. Date: Apr. 30, 2026

(54) REFLECTION MODULE AND CAMERA MODULE INCLUDING REFLECTION MODULE

(71) Applicant: Samsung Electro-Mechanics Co., Ltd., Suwon-si (KR)

(72) Inventors: Yun Gu LEE, Suwon-si (KR); Po Chul KIM, Suwon-si (KR); Ta Kyoung LEE, Suwon-si (KR)

(73) Assignee: Samsung Electro-Mechanics Co., Ltd., Suwon-si (KR)

(21) Appl. No.: 19/278,223

(22) Filed: Jul. 23, 2025

(30) Foreign Application Priority Data
Oct. 29, 2024 (KR) 10-2024-0149503

(51) Int. Cl. G02B 7/182; G02B 13/00

(52) U.S. Cl. CPC G02B 7/1827; G02B 13/0065

(57) ABSTRACT

A reflection module includes a housing; a rotation carrier disposed in the housing; a reflection member holder supported on the rotation carrier to be rotatable about a first axis; a reflection member disposed on the reflection member holder; and a first ball member contacting the rotation carrier and the reflection member holder and forming the first axis, wherein the first ball member includes a plurality of ball members spaced apart from each other in a direction of the first axis, and a plurality of contact points formed by the plurality of ball members with the reflection member holder and a plurality of contact points formed by the plurality of ball members with the rotation carrier are disposed at different positions in a direction of a second axis perpendicular to the first axis.

### CROSS-REFERENCE TO RELATED APPLICATIONS

This application claims the benefit under 35 USC 119 (a) of Korean Patent Application No. 10-2024-0149503 filed on Oct. 29, 2024, in the Korean Intellectual Property Office, the entire disclosure of which is incorporated herein by reference for all purposes.

### BACKGROUND

### 1. Field

The present disclosure relates to a reflection module and a camera module including a reflection module.

### 2. Description of Background

Camera modules provided in mobile devices have been manufactured to have performance comparable to that of conventional cameras. Specifically, as the frequency of users taking videos using mobile devices increases, a demand for camera modules that may provide high zoom ratios has increased.

In order to provide high zoom ratios, a camera module needs to have a sufficiently long total track length (TTL). However, since mobile devices are gradually becoming smaller, there may be spatial constraints in increasing the total track length of the camera module.

Recently, a reflector that may bend an optical path of light may be installed in the camera module to lengthen the optical path without significantly increasing the thickness of the camera module.

Typically, a camera module including a reflector drives the reflector to compensate for shaking. However, there are various difficulties in implementing stable and precise driving due to the weight of the reflector.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a reflection module includes a housing; a rotation carrier disposed in the housing; a reflection member holder supported on the rotation carrier to be rotatable about a first axis; a reflection member disposed on the reflection member holder; and a first ball member contacting the rotation carrier and the reflection member holder and forming the first axis, wherein the first ball member includes a plurality of ball members spaced apart from each other in a direction of the first axis, and a plurality of contact points formed by the plurality of ball members with the reflection member holder and a plurality of contact points formed by the plurality of ball members with the rotation carrier are disposed at different positions in a direction of a second axis perpendicular to the first axis.

The reflection member holder may include a first accommodating groove and a second accommodating groove spaced apart from each other in the first axis direction and accommodating a portion of the first ball member, and the rotation carrier may include a third accommodating groove facing the first accommodating groove and a fourth accommodating groove facing the second accommodating groove and accommodating another portion of the first ball member.

3. The reflection module of claim 2, wherein the plurality of ball members of the first ball member may include a main ball member disposed between the first accommodating groove and the third accommodating groove, and a sub-ball member disposed between the second accommodating groove and the fourth accommodating groove, and a number of contact points formed by the main ball member with the first accommodating groove and the third accommodating groove may be greater than a number of contact points formed by the sub-ball member with the second accommodating groove and the fourth accommodating groove.

The main ball member may be in three-point contact with each of the first accommodating groove and the third accommodating groove, and the sub-ball member may be in two-point contact with one of the second accommodating groove and the fourth accommodating groove, and may be in three-point contact with another one of the second accommodating groove and the fourth accommodating groove.

Each of the first accommodating groove, the second accommodating groove, the third accommodating groove, and the fourth accommodating groove may include a plurality of inclination surfaces inclined in different directions relative to each other, and the first ball member may be in contact with some of the inclination surfaces.

One of the first accommodating groove and the second accommodating groove may include three inclination surfaces in contact with the first ball member, and another one of the first accommodating groove and the second accommodating groove may include two inclination surfaces in contact with the first ball member.

Each of the third accommodating groove and the fourth accommodating groove may include three inclination surfaces in contact with the first ball member, and the three inclination surfaces of the third accommodating groove may be inclined in different directions relative to the three inclination surfaces of the fourth accommodating groove.

The first ball member may form three contact points with portions of the first accommodating groove, the third accommodating groove, and the fourth accommodating groove, and a virtual triangle formed by connecting the three contact points may be symmetrical with respect to a first line extending in a direction parallel to the first axis and asymmetrical with respect to a second line extending in a direction parallel to the second axis.

The reflection member holder may be supported on the rotation carrier in a direction of a third axis perpendicular to both the first axis and the second axis perpendicular to the first axis.

The reflection module may further include a first magnetic body disposed on the reflection member holder; and a second magnetic body disposed on the rotation carrier and facing the first magnetic body in the third axis direction.

The rotation carrier may be disposed in the housing to be rotatable about the second axis perpendicular to the first axis, and the reflection member holder may be rotatable about the second axis together with the rotation carrier.

In another general aspect, a camera module includes the reflection module described above; and a lens module including a plurality of lenses configured to refract light passing through the reflection module.

In another general aspect, a reflection module includes a housing; a rotation carrier disposed in the housing; a reflection member holder supported on the rotation carrier to be rotatable about a first axis; a reflection member disposed on the reflection member holder; and a first ball member disposed between the rotation carrier and the reflection member holder and forming the first axis, wherein the first ball member forms three contact points with either one or both of the rotation carrier and the reflection member holder, and all three sides of a virtual triangle defined by lines connecting the three contact points to each other have lengths in directions oblique to a direction parallel to the first axis.

The first ball member may include a main ball member forming three contact points with each of the reflection member holder and the rotation carrier, and a sub-ball member forming three contact points with either one of the reflection member holder and the rotation carrier, and the main ball member and the sub-ball member may be spaced apart from each other in a direction of the first axis.

The three contact points formed by the first ball member with the reflection member holder and the rotation carrier may be disposed at different positions in a direction of a second axis perpendicular to the first axis.

The reflection member holder may be supported on the rotation carrier in a direction of a third axis perpendicular to both the first axis and a second axis perpendicular to the first axis, with the first ball member being interposed between the reflection member holder and the rotation carrier.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is an internal perspective view of the camera module of FIG. 1.

FIG. 3 is a schematic exploded perspective view of the camera module of FIGS. 1 and 2.

FIG. 4 is a perspective view of a first lens module and a reflection module of the camera module of FIGS. 1 to 3.

FIGS. 5 and 6 are exploded perspective views of the first lens module and the reflection module of FIG. 4.

FIG. 7 is a cross-sectional view taken along the line VII-VII′ of FIG. 4.

FIG. 8 is a cross-sectional view taken along the line VIII-VIII′ of FIG. 4.

FIG. 9 is an enlarged view of one side and accommodating grooves of a reflection member holder supported on a rotation carrier as shown in FIGS. 5 and 6.

FIG. 10 is an enlarged view of one side and accommodating grooves of the rotation carrier on which the reflection member holder is supported as shown in FIGS. 5 and 6.

FIG. 11 is a view illustrating a main rotation guide of FIGS. 9 and 10.

FIG. 12 is a view illustrating a sub-rotation guide of FIGS. 9 and 10.

FIG. 13 is an enlarged view of one side and accommodating grooves of a refection member holder supported on a rotation carrier according to another embodiment of the present disclosure

FIG. 14 is an enlarged view of one side and accommodating grooves of the rotation carrier on which the reflection member holder is supported according to the embodiment of FIG. 13.

FIGS. 15 and 16 are exploded perspective views of a second lens module of the camera module of FIGS. 1 to 3.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The present disclosure relates to a reflection module and a camera module including a reflection module. The camera module according to the present disclosure may be used in portable electronic devices such as a smart phone, a tablet PC, and any other portable device.

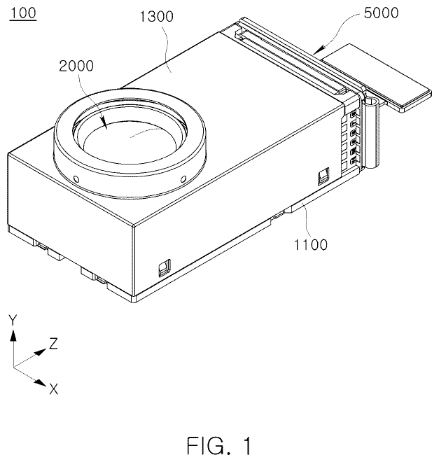

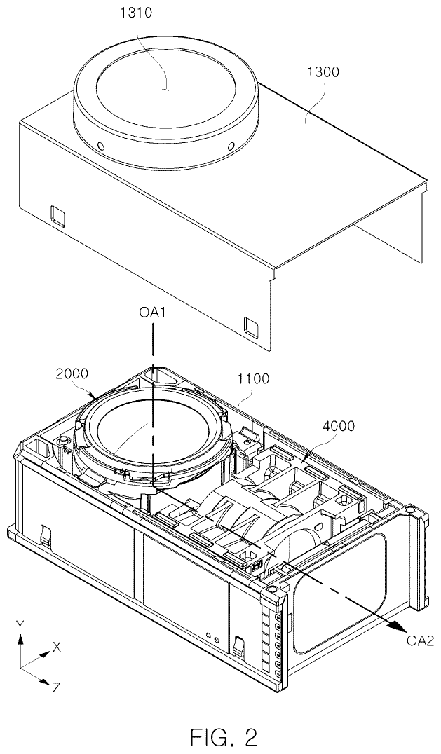

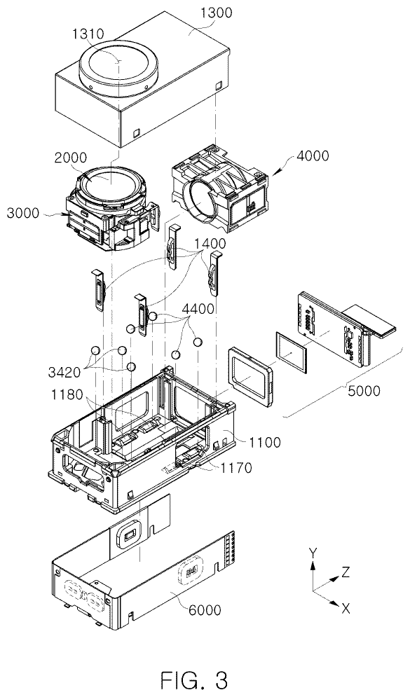

FIG. 1 is a perspective view of a camera module according to an embodiment of the present disclosure, FIG. 2 is an internal perspective view of the camera module of FIG. 1, and FIG. 3 is a schematic exploded perspective view of the camera module of FIGS. 1 to 3.

Referring to FIG. 1, a camera module 100 may have a rectangular prism shape defined by a length (Z-direction), a width (X-direction), and a height (Y-direction).

For example, the camera module 100 may be disposed in a portable electronic device so that a height direction corresponds to a thickness direction of the portable electronic device. Accordingly, a length of the camera module 100 may not affect a thickness of the portable electronic device.

Referring to FIGS. 1 and 2, the camera module 100 may have a structure in which light is incident on one side of a length direction in a height direction of the camera module 100 and an image is formed on the other side of the length direction.

As described above, since a length of the camera module 100 does not affect a thickness of the portable electronic device, the light may move along a relatively long movement path inside the camera module 100.

Referring to FIGS. 1 to 3, the camera module 100 may include a housing 1100, a case 1300, a plurality of lens modules 2000 and 4000 (hereinafter, a first lens module 2000 and a second lens module 2000), a reflection module 3000, and an image sensor module 5000.

Light incident on the camera module 100 may sequentially pass through the first lens module 2000, the reflection module 3000, and the second lens module 4000, and then be incident on the image sensor module 5000.

The camera module 100 may include the first lens module 2000 and the second lens module 4000 having different optical axes. For example, the first lens module 2000 may have a first optical axis OA1, and the second lens module 4000 may have a second optical axis OA2.

The first optical axis OA1 may be parallel to the height direction of the camera module 100, and the second optical axis OA2 may be parallel to the length direction of the camera module 100. That is, the first optical axis OA1 and the second optical axis OA2 may be substantially perpendicular to each other.

The reflection module 3000 may be disposed between the first lens module 2000 and the second lens module 4000 to change a light movement path from the first optical axis direction to the second optical axis direction.

The housing 1100 may have an internal space accommodating the first lens module 2000, the reflection module 3000, and the second lens module 4000. Additionally, the housing 1100 may include a bottom surface and a plurality of side surfaces defining the internal space, and the image sensor module 5000 may be disposed on one side surface of the housing 1100.

The first lens module 2000, the reflection module 3000, and the second lens module 4000 may be supported in the housing 1100 by a plurality of ball members. The plurality of ball members may enable movements of the first lens module 2000, the reflection module 3000, and the second lens module 4000.

In an embodiment, the first lens module 2000 and the reflection module 3000 may be rotatable about a plurality of rotation axes of the camera module 100 to correct the shaking of the camera module 100. Additionally, the second lens module 4000 may be movable in a direction of the second optical axis OA2, i.e., an optical axis of the second lens module 4000, to adjust a focus of the camera module 100 and change a focal length of the camera module 100.

The case 1300 may be a member coupled to the housing 1100 to cover the internal space of the housing 1100.

The case 1300 may include an opening 1310 allowing light to be incident on the first lens module 2000. For example, a portion of the first lens module 2000 through which light is incident may be exposed through the opening 1310.

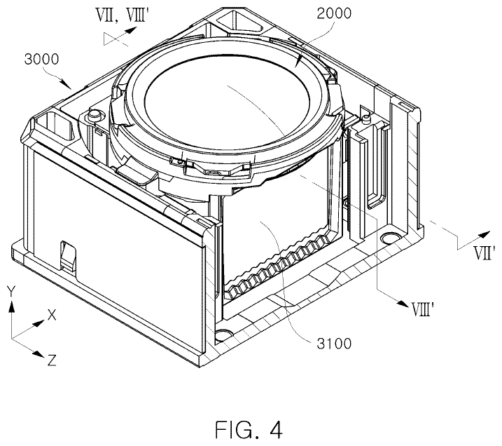

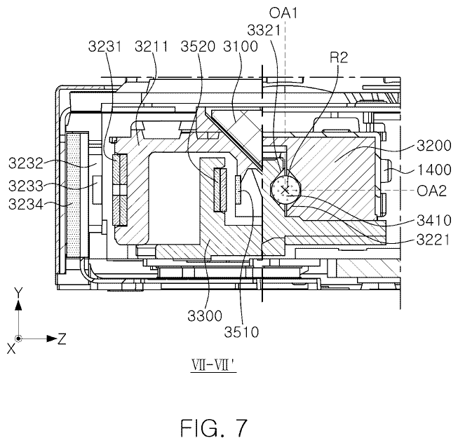

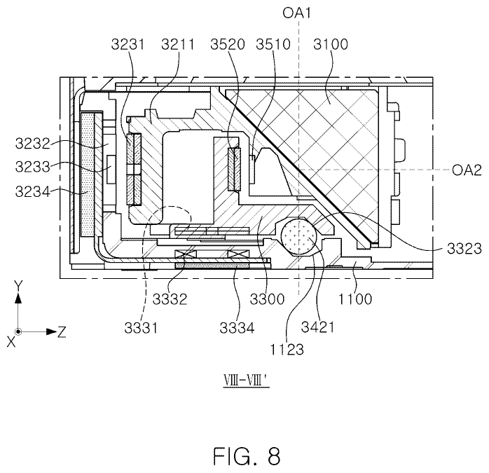

FIG. 4 is a perspective view of a first lens module and a reflection module of the camera module of FIGS. 1 to 3, FIGS. 5 and 6 are exploded perspective views of the first lens module and the reflection module of FIG. 4, FIG. 7 is a cross-sectional view taken along the line VII-VII′ of FIG. 4, and FIG. 8 is a cross-sectional view taken along the line VIII-VIII′ of FIG. 4.

Referring to FIG. 4, the first lens module 2000 and the reflection module 3000 may be disposed in a coupled state in the housing 1100. For example, the first lens module 2000 and the reflection module 3000 may be disposed in the first optical axis direction, and the first lens module 2000 may be disposed in front of the reflection module 3000 relative to the movement path of light.

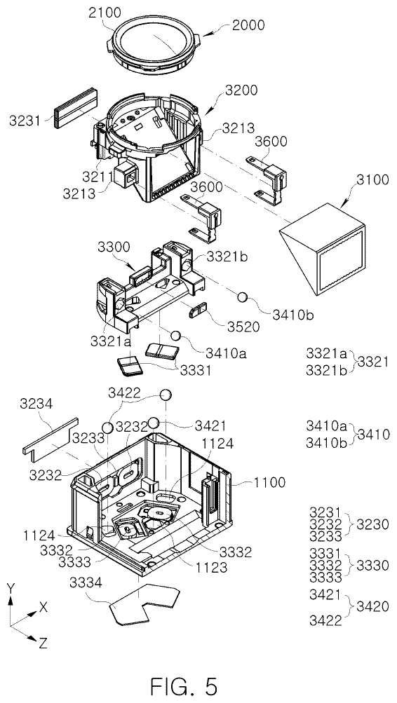

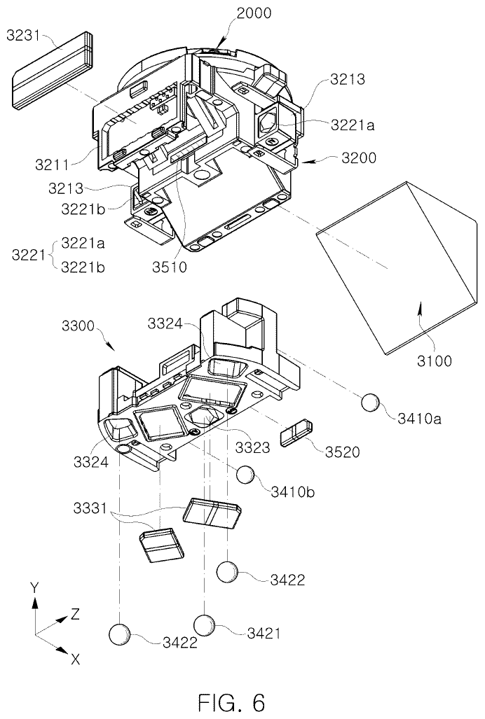

Referring to FIGS. 5 and 6, the first lens module 2000 may include one or more lenses and a first lens holder 2100 in which the one or more lenses are mounted.

The reflection module 3000 may include a reflection member 3100, a reflection member holder 3200 on which the reflection member 3100 is mounted, a rotation carrier 3300 on which the reflection member holder 3200 is supported, and a plurality of drivers 3230 and 3330 (hereinafter, a first driver 3230 and a second driver 3330) that rotate the reflection member holder 3200 and the rotation carrier 3300, respectively.

Light incident on the camera module 100 may pass through the one or more lenses of the first lens module 2000, may be incident on the reflection member 3100, and may be reflected and refracted by the reflection member 3100 to be directed toward the second lens module 4000 to change the movement path of light.

The reflection member 3100 may include a reflective surface reflecting light. For example, the reflection member 3100 may be a prism including an incident surface, a reflective surface, and an exit surface.

The reflective surface of the reflection member 3100 may be disposed obliquely with respect to the incident surface and the exit surface (or the first optical axis OA1 and the second optical axis OA2). For example, the first optical axis OA1 may pass through the incident surface and the reflective surface of the reflection member 3100, and the second optical axis OA2 may pass through the reflective surface and the exit surface of the reflection member 3100. In other words, the first optical axis OA1 and the second optical axis OA2 may intersect each other on the reflective surface.

The reflection member 3100 may be rotatable about two axes that are perpendicular to each other as rotational axes.

The reflection member holder 3200 on which the reflection member 3100 is mounted may be rotatable about the first axis (X-axis). In an embodiment, the first lens holder 2100 coupled to the reflection member holder 3200 may be rotated with the reflection member holder 3200 about the first axis (X-axis). The first axis (X-axis) may be an axis perpendicular to the first optical axis OA1.

The rotation carrier 3300 supporting the reflection member holder 3200 may be rotatable about the second axis (Y-axis). In an embodiment, the reflection member holder 3200 may be rotated about the second axis (Y-axis) together with the rotation carrier 3300. The second axis (Y-axis) may be an axis parallel to the first optical axis OA1.

The first driver 3230 may include a first driving magnet 3231, a first driving coil 3232, and a first position sensor 3233.

The reflection member holder 3200 may be rotated about the first axis (X-axis) by an electromagnetic interaction between the first driving magnet 3231 and the first driving coil 3232.

The first driving magnet 3231 and the first driving coil 3232 may be disposed to face each other. In an embodiment, the first driving magnet 3231 may be disposed on the reflection member holder 3200. The reflection member holder 3200 may include an extension portion 3211 disposed between the rotation carrier 3300 and the housing 1100 by extending from a portion of the reflection member holder 3200 on which the reflection member 3100 is mounted, and the first driving magnet 3231 may be disposed on the extension portion 3211. The first driving coil 3232 may be disposed on one side of the housing 1100 facing the extension portion 3211 on which the first driving magnet 3231 is disposed.

The first driving magnet 3231 may be magnetized so that a surface thereof facing the first driving coil 3232 includes an N pole (or an S pole), a neutral region, and an S pole (or an N pole) disposed in sequential order along a movement direction of the reflection member holder 3200.

The first position sensor 3233 may also be disposed on the housing 1100 to face the first driving magnet 3231. For example, the first position sensor 3233 may be a magnetic sensor sensing a change in a magnetic flux of the first driving magnet 3231 to sense a position of the reflection member holder 3200. In order to efficiently detect a change in the magnetic flux, the first position sensor 3233 may face the neutral region of the first driving magnet 3231.

The first driving coil 3232 and the first position sensor 3233 may be attached to a main board 6000 (see FIG. 3) disposed on side surfaces and a bottom surface of the housing 1100.

The first driving coil 3232 and the first position sensor 3233 may be disposed on one surface of the main board 6000, and the first position sensor 3233 may be disposed inside or outside of the first driving coil 3232 on the one surface of the main board 6000.

A through-hole may be formed in one side surface of the housing 1100, and the main board 6000 may be disposed on the housing 1100 so that the one surface of the main board 6000 on which the first driving coil 3232 and the first position sensor 3233 are disposed is exposed to the internal space of the housing 1100 through the through-hole. Accordingly, the first driving magnet 3231 may directly face the first driving coil 3232 and the first position sensor 3233 through the through-hole.

A first yoke 3234 may be disposed on the main board 6000. The first yoke 3234 is disposed on an opposite surface of the main board 6000 from the one surface of the main board 6000 on which the first driving coil 3232 and the first position sensor 3233 are disposed, and may block leakage of the magnetic flux generated by the first driving magnet 3231.

A plurality of ball members (hereinafter, a first ball member 3410) supporting the rotation of the reflection member holder 3200 about the first axis (X-axis) may be disposed between the reflection member holder 3200 and the rotation carrier 3300. For example, the first ball member 3410 may include two ball members 3410a and 3410b spaced apart from each other in a first axis (X-axis) direction. The first axis (X-axis) may pass through the two ball members 3410a and 3410b.

The first ball member 3410 may be fitted between accommodating grooves 3221 and 3321 provided in the reflection member holder 3200 and the rotation carrier 3300, respectively. Each of the accommodating grooves 3221 and 3321 may be provided in a number (two) corresponding to a number of ball members (two) of the first ball member 3410.

In an embodiment, the reflection member holder 3200 and the rotation carrier 3300 may be provided with accommodating grooves 3221 and 3321 (hereinafter, first to fourth accommodating grooves 3221a, 3221b, 3321a, and 3321b) into which the first ball member 3410 is inserted.

In an embodiment, the reflection member holder 3200 may include a first accommodating groove 3221a and a second accommodating groove 3221b spaced apart from each other in the first axis (X-axis) direction, and the rotation carrier 3300 may include a third accommodating groove 3321a and a fourth accommodating groove 3321b spaced apart from each other in the first axis (X-axis) direction.

The accommodating grooves 3221 provided in the reflection member holder 3200 and the accommodating grooves 3321 accommodated in the rotation carrier 3300 may face each other in a second optical axis (Z-axis) direction with the first ball member 3410 interposed therebetween.

The first ball member 3410 may support the rotation of the reflection member holder 3200 with the first axis (X-axis) as a rotation axis while rotating in place with the first ball member 3410 being fitted into the accommodating grooves 3221 and 3321. Since a position of the first ball member 3410 should not move, the first ball member 3410 may be supported at three points in at either one or both of the accommodating grooves 3221 and 3321.

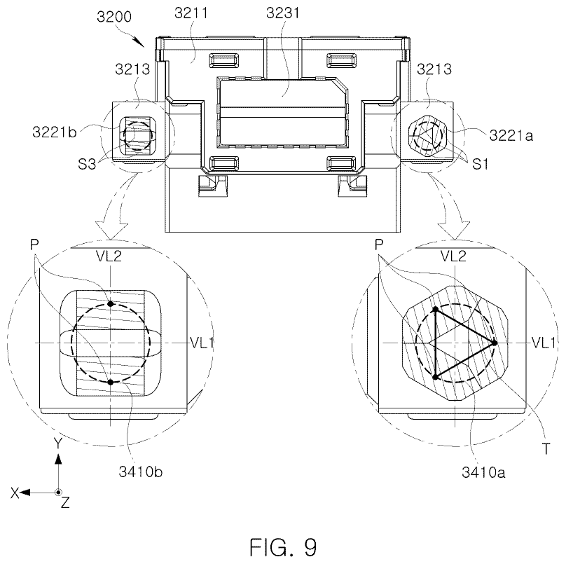

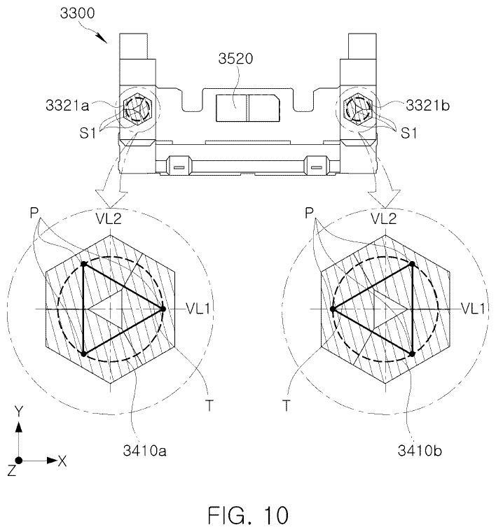

FIG. 9 is an enlarged view of one side and accommodating grooves of a reflection member holder supported on a rotation carrier as shown in FIGS. 5 and 6, FIG. 10 is an enlarged view of one side and accommodating grooves of the rotation carrier on which the reflection member holder is supported as shown in FIGS. 5 and 6, FIG. 11 is a view illustrating a main rotation guide of FIGS. 9 and 10, and FIG. 12 is a view illustrating a sub-rotation guide of FIGS. 9 and 10.

Referring to FIG. 9, the reflection member holder 3200 may include protrusion portions 3213 protruding in the first axis (X-axis) direction on both sides of the reflection member holder 3200 on which the reflection member 3100 is mounted, and the first accommodating groove 3221a and the second accommodating groove 3221b may be provided in the protrusion portions 3213.

The first accommodating groove 3221a and the second accommodating groove 3221b may have different cross-sectional shapes. For example, the first accommodating groove 3221a may include at least three inclination surfaces inclined in different directions relative to each other, and the second accommodating groove 3221b may include at least two inclination surfaces inclined in different directions relative to each other.

Referring to FIG. 10, the rotation carrier 3300 may include a third accommodating groove 3321a provided in a position facing the first accommodating groove 3221a of the reflection member holder 3200 in a state in which the reflection member holder 3200 is supported by the rotation carrier 3300, and a fourth accommodating groove 3321b provided in a position facing the second accommodating groove 3221b of the reflection holder in the state in which the reflection member holder 3200 is supported by the rotation carrier 3300.

The third accommodating groove 3321a and the fourth accommodating groove 3321b may have different cross-sectional shapes. The third accommodating groove 3321a and the fourth accommodating groove 3321b may each include at least three inclination surfaces inclined in different directions relative to each other. For example, the inclination surfaces of the third accommodating groove 3321a with which the first ball member 3410 comes into contact may be inclined in different directions relative to each other and relative to the inclination surfaces of the fourth accommodating groove 3321b with which the first ball member 3410 comes into contact. Also, the inclination surfaces of the fourth accommodating groove 3321b with which the first ball member 3410 comes into contact may be inclined in different directions relative to each other and relative to the inclination surfaces of the third accommodating groove 33211 with which the first ball member 3410 comes into contact.

The first ball member 3410 may form contact points P with some of the inclination surfaces of the accommodating grooves 3221 and 3321. The first ball member 3410 may form three contact points P with some of the accommodating grooves 3221 and 3321 and two contact points P with some of the accommodating grooves 3221 and 3321.

For example, the first ball member 3410 may form three contact points P (three-point support) with the first accommodating groove 3221a provided in the reflection member holder 3200, and the third accommodating groove 3321a and the fourth accommodating groove 3321b provided in the rotation carrier 3300, and may form two contact points P (two-point support) with the second accommodating groove 3221b provided in the reflection member holder 3200.

In another embodiment, the accommodating groove forming two contact points P with the first ball member 3410 may be provided in the rotation carrier 3300 instead of in the reflection member holder 3200.

Since the first ball member 3410 is supported at three points in the first accommodating groove 3221a, the third accommodating groove 3321a, and the fourth accommodating groove 3321b, the first ball member 3410 may rotate in place at a position constrained in three directions in response to a driving force generated by the first driver 3230. At the same time, since the first ball member 3410 is supported at two points in the second accommodating groove 3221b to have a degree of freedom in one direction, an assembly tolerance of the reflection holder member 3200 and the rotation carrier 3300 may be eliminated.

In an embodiment, the two ball members 3410a and 3410b of the first ball member 3410 may form different numbers of contact points P with the accommodating grooves 3221 and 3321. For example, the ball member 3410a disposed between the first accommodating groove 3221a and the third accommodating groove 3321a may form a greater number of contact points P with the accommodating grooves 3221 and 3321 than the ball member 3410b disposed between the second accommodating groove 3221b and the fourth accommodating groove 3321b. Accordingly, the ball member 3410a disposed between the first accommodating groove 3221a and the third accommodating groove 3321a may more stably support the rotation of the reflection member holder 3200 than the ball member 3410b disposed between the second accommodating groove 3221b and the fourth accommodating groove 3321b, so the ball member 3410a may become a main ball member (hereinafter, a main ball member 3410a), and the ball member 3410b disposed between the second accommodating groove 3221b and the fourth accommodating groove 3321b may become a sub-ball member (hereinafter, a sub-ball member 3410b). Similarly, the first accommodating groove 3221a and the third accommodating groove 3321a accommodating a portion of the main ball member 3410a may become a main rotation guide, and the second accommodating groove 3221b and the fourth accommodating groove 3321b accommodating a portion of the sub-ball member 3410b may become a sub-rotation guide.

In an embodiment, the accommodating grooves coming into three-point contact with the first ball member 3410, i.e., the first accommodating groove 3221a, the third accommodating groove 3321a, and the fourth accommodating groove 3321b, may have a shape similar to a shape in which each corner is cut from a triangular pyramid (tetrahedron) shape.

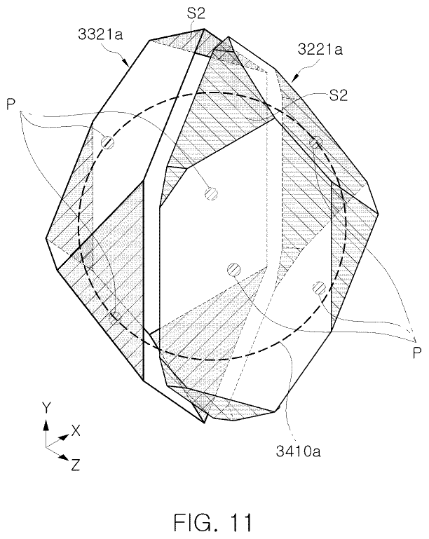

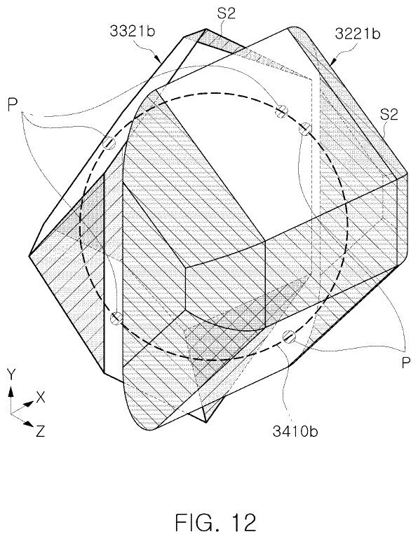

The first accommodating groove 3221a, the third accommodating groove 3321a, and the fourth accommodating groove 3321b may include three inclination surfaces (hereinafter, first inclination surfaces S1) with which the first ball member 3410 comes into contact, and a plurality of inclination surfaces (hereinafter, second inclination surfaces S2) (see FIGS. 11 and 12) with which the first ball member 3410 does not come into contact. For example, the number of second inclination surfaces S2 may be greater than the number of first inclination surfaces S1 in each of the accommodating grooves 3221a, 3321a, and 3321b.

Each of the first inclination surfaces S1 may correspond to one of the four faces of the triangular pyramid. For example, three first inclination surfaces S1 may be portions of three side surfaces of the triangular pyramid, because the corners of the triangular pyramid are cut off. Accordingly, one first inclination surface S1 may intersect the other two first inclination surfaces S1 on both sides. The second inclination surfaces S2 may correspond to a cross-section formed by cutting each corner of the triangular pyramid once or twice. Accordingly, the second inclination surfaces S2 may be spaced apart from each other.

In an embodiment, the first accommodating groove 3221a, the third accommodating groove 3321a, and the fourth accommodating groove 3321b may be symmetrical with respect to a virtual straight line (hereinafter, a first line VL1) extending in a direction parallel to the first axis (X-axis) and passing through centers of the main ball member 3410a and the sub-ball member 3410b based on the center of rotation of the reflection member holder 3200. The first line VL1 may pass through one of the three first inclination surfaces S1 of the accommodating grooves 3221a, 3321a, and 3321b (or may overlap one first inclination surface S1). At the same time, the first accommodating groove 3221a, the third accommodating groove 3321a, and the fourth accommodating groove 3321b may be asymmetrical with respect to a virtual straight line (hereinafter, a second line VL2) extending in a direction parallel to a second axis (Y-axis) perpendicular to the first axis (X-axis). The second line VL2 may pass through two of the three first inclination surfaces S1 of the accommodating grooves 3221a, 3321a, and 3321b (or may overlap two first inclination surfaces S1). In this case, the first inclination surface S1 through which the first line VL1 passes and the two first inclination surfaces S1 through which the second line VL2 passes may not overlap each other.

The first line VL1 and second line VL2 are not limited to one specific line, and all straight lines extending in a direction parallel to the first axis (X-axis) and passing through one of the three first inclination surfaces S1 at any position may correspond to the first line VL1, and similarly, all straight lines extending in a direction parallel to the second axis (Y-axis) and passing through two of the three first inclination surfaces S1 at any position may correspond to the second line VL2.

The first ball member 3410 may be in contact with the accommodating grooves 3221a, 3321a, and 3321b on the three first inclination surfaces S1. The contact points formed by the first ball member 3410 with the three first inclination surfaces S1 may be disposed approximately in the center of the three first inclination surfaces S1.

The first ball member 3410 may form three contact points P in each of the first accommodating groove 3221a, the third accommodating groove 3321a, and the fourth accommodating groove 3321b. The contact points P formed by the first ball member 3410 with each of the accommodating grooves 3221a, 3321a, and 3321b may be formed at different positions in the second axis (Y-axis) direction. For example, the three contact points P formed by the first ball member 3410 with each of the accommodating grooves 3221a, 3321a, and 3321b may be disposed on the first axis (X-axis), on one side (e.g., an upper side based on the drawing) of the first axis (X-axis), and on another side (e.g., a lower side based on the drawing) of the first axis (X-axis), respectively. That is, the first ball member 3410 may be supported at three points in each of the accommodating grooves 3221a, 3321a, and 3321b at different heights. For example, a virtual triangle T formed by connecting the three contact points P formed by the first ball member 3410 with the accommodating grooves 3221a, 3321a, and 3321b may be symmetrical with respect to the first line VL1 and asymmetrical with respect to the second line VL2. Additionally, all three sides of the virtual triangle T may have lengths in respective directions oblique to the first axis (X-axis) (or the first line VL1.

The second accommodating groove 3221b may include two inclination surfaces (hereinafter, third inclination surfaces S3) with which the first ball member 3410 comes into contact, and a plurality of inclination surfaces (hereinafter, fourth inclination surfaces) with which the first ball member 3410 does not come into contact. The number of fourth inclination surfaces may be greater than the number of third inclination surfaces S3 in the second accommodating groove 3221b.

The first ball member 3410 may form two contact points P in the second accommodating groove 3221b. The contact points P formed by the first ball member 3410 in the second accommodating groove 3221b may be formed at different positions in the second axis (Y-axis) direction. For example, one of the two contact points P may be formed on one side (e.g., an upper side based on the drawing) of the first axis (X-axis), and the other one of the two contact points P may be formed on another side (e.g., a lower side based on the drawing) of the first axis (X-axis). A virtual line VL2 connecting the two contact points P to each other may be approximately parallel to the second axis (Y-axis).

Referring to FIG. 11, different portions of the main ball member 3410a may be accommodated in the first accommodating groove 3221a and the third accommodating groove 3321a, respectively. The main ball member 3410a may form three contact points P with each of the accommodating grooves 3221a and 3321a. That is, the main ball member 3410a may be supported at a total of six points in the first accommodating groove 3221a and the third accommodating groove 3321a. The main ball member 3410a may be supported at different positions in the second axis (Y-axis) direction in each of the accommodation grooves 3221a and 3321a. Accordingly, the main ball member 3410a may be stably rotated in a state of being supported at three points in each of the accommodating grooves 3221a and 3321a without fail in a specific direction. The hatched surfaces in FIG. 11 are the second inclination surfaces S2 referred to above.

Referring to FIG. 12, different portions of the sub-ball member 3410b may be accommodated in the second accommodating groove 3221b and the fourth accommodating groove 3321b, respectively. The sub-ball member 3410b may form two contact points P with the second accommodating groove 3221b, and may form three contact points P with the fourth accommodating groove 3321b. That is, the sub-ball member 3410b may be supported at a total of five points in the second accommodating groove 3221b and the fourth accommodating groove 3321b. The hatched surfaces in FIG. 12 are the second inclination surfaces S2 referred to above.

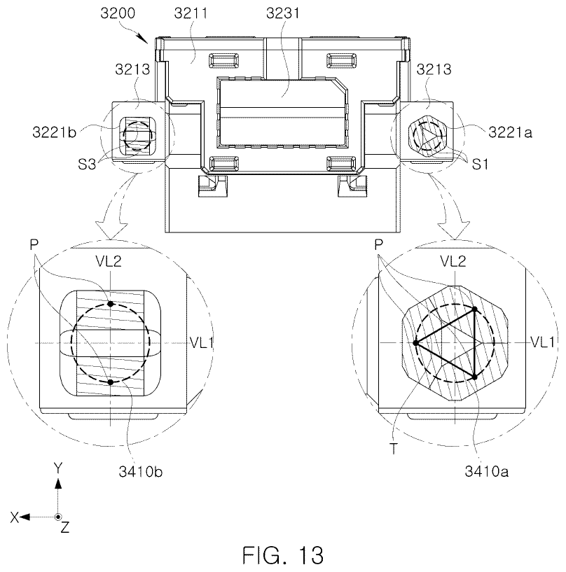

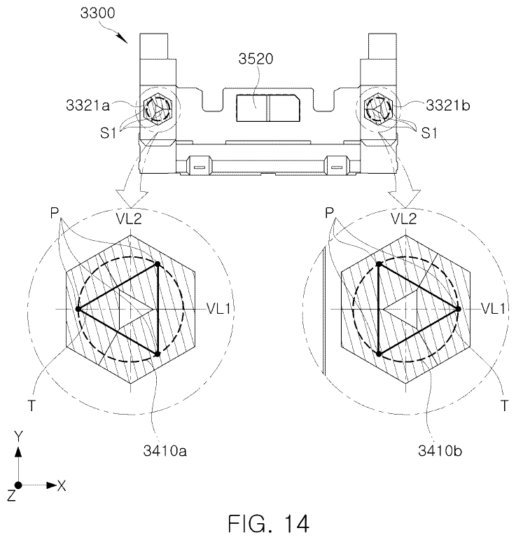

FIG. 13 is an enlarged view of one side and accommodating grooves of a reflection member holder supported on a rotation carrier according to another embodiment of the present disclosure, and FIG. 14 is an enlarged view of one side and accommodating grooves of the rotation carrier on which the reflection member holder is supported according to the embodiment of FIG. 13.

As a modified embodiment, as illustrated in FIGS. 13 and 14, even if the first accommodating groove 3221a, the third accommodating groove 3321a, and the fourth accommodating groove 3321b are rotated by a certain angle relative to the first accommodating groove 3221a, the third accommodating groove 3321a, and the fourth accommodating groove 3321b shown in FIGS. 9 and 10, for example, by 180° as shown in FIGS. 13 and 14, the same effect as in the above-described embodiment of FIGS. 9 and 10 may be obtained.

In addition to the embodiments illustrated in the drawings, each of the accommodating grooves 3221a, 3321a, and 3321b may be provided in other forms in which the first ball member 3410 is supported at different positions in the second axis (Y-axis) direction.

The reflection member holder 3200 may be supported on the rotation carrier 3300 with the first ball member 3410 interposed therebetween. For example, the reflection member holder 3200 may be supported by the housing 1100 by an attractive force generated between a pair of magnetic bodies 3510 and 3520.

The pair of magnetic bodies 3510 and 3520 may be divided and disposed to face each other on the reflection member holder 3200 and the rotation carrier 3300. For example, the pair of magnetic bodies 3510 and 3520 may be a pulling magnet (a first magnetic body) and a pulling yoke (a second magnetic body).

The pair of magnetic bodies 3510 and 3520 may generate the attractive force in a direction in which the magnetic bodies 3510 and 3520 face each other. Accordingly, the reflection member holder 3200 and the first ball member 3410 may be pressed against the rotation carrier 3300 in the second optical axis (or third axis) direction (Z-axis direction based on the drawing) by the attractive force.

The reflection module 3000 may include a stopper 3600 configured to limit a range of movement (rotation) of the reflection member holder 3200 and absorb shocks and noise generated during a collision.

The stopper 3600 may be coupled to the rotation carrier 3300 to surround a portion of the reflection member holder 3200. For example, the stopper 3600 may be arranged to surround the two protrusion portions 3213 of the reflection member holder 3200 spaced apart from each other in the first axis (X-axis) direction.

The stopper 3600 may be provided with a damper to surround a portion of the stopper 3600. A gap may be formed between the damper of the stopper 3600 and the reflection member holder 3200. The reflection member holder 3200 may be in contact with the damper in a state in which the reflection member holder 3200 is rotated to a maximum angle about the first axis (X-axis). Accordingly, the damper may be made of a material capable of absorbing shocks and noise.

The second driver 3330 may include a second driving magnet 3331, a second driving coil 3332, and a second position sensor 3333.

The rotation carrier 3300 may be rotated about the second axis (Y-axis) by an electromagnetic interaction between the second driving magnet 3331 and the second driving coil 3332.

The second driving magnet 3331 and the second driving coil 3332 may be disposed to face each other. For example, the second driving magnet 3331 may be disposed on one surface of the rotation carrier 3300, and the second driving coil 3332 may be disposed on one surface of the housing 1100 facing the one surface of the rotation carrier 3300 on which the second driving magnet 3331 is disposed.

The second driving magnet 3331 and the second driving coil 3332 may be provided in plural. For example, two second driving magnets 3331 and two second driving coils 3332 may be provided, and may be disposed on opposite sides of the second axis (Y-axis).

The second driving magnet 3331 may be magnetized so that a surface facing the second driving coil 3332 includes an N pole (or an S pole), a neutral region, and an S pole (or an N pole) disposed in sequential order in a movement direction of the rotation carrier 3300.

The second position sensor 3333 may also be disposed in the housing 1100 to face the second driving magnet 3331. For example, the second position sensor 3333 may be a magnetic sensor sensing a change in a magnetic flux of the second driving magnet 3331 to sense a position of the rotation carrier 3300. In order to efficiently sense the change in the magnetic flux, the second position sensor 3333 may face the neutral region of the second driving magnet 3331.

The second driving coil 3332 and the second position sensor 3333 may be attached to the main board 6000 (see FIG. 3) disposed on side surfaces and a bottom surface of the housing 1100.

The second driving coil 3332 and the second position sensor 3333 may be disposed on one surface of the main board 6000, and the second position sensor 3333 may be disposed inside or outside of the second driving coil 3332 on the one surface of the main board 6000.

A through-hole may be formed in the bottom surface of the housing 1100, and the main board 6000 may be disposed on the housing 1100 so that the one surface of the main board 6000 on which second first driving coil 3332 and the second position sensor 3333 are disposed is exposed to the internal space of the housing 1100 through the through-hole. Accordingly, the second driving magnet 3331 may directly face the second driving coil 3332 and the second position sensor 3333 through the through-hole.

A second yoke 3334 may be disposed on the main board 6000. The second yoke 3334 may be disposed on an opposite surface of the main board 6000 from the one surface of the main board 6000 on which the second driving coil 3332 and the second position sensor 3333 are disposed to block leakage of the magnetic flux generated by the second driving magnet 3331.

A plurality of ball members (hereinafter, a second ball member 3420) supporting rotation of the rotation carrier 3300 about the second axis (Y-axis) may be disposed between the rotation carrier 3300 and the housing 1100. For example, the second ball member 3420 may include one rotation shaft ball 3421 through which the second axis (Y-axis) passes, and a plurality of guide balls 3422 spaced apart from the rotation shaft ball 3421. The plurality of guide balls 3422 may include two or more ball members.

The second ball member 3420 may be fitted between an accommodating groove and guide grooves provided in the rotation carrier 3300 and an accommodating groove and guide grooves provided in the housing 1100.

The rotation carrier 3300 and the housing 1100 may be provided with accommodating grooves (hereinafter, a fifth accommodating groove 3323 and a sixth accommodating groove 1123) into which the rotation shaft ball 3421 is inserted. The fifth accommodating groove 3323 and the sixth accommodating groove 1123 may face each other in the second axis (Y-axis) direction.

Each of the fifth accommodating groove 3323 and the sixth accommodating groove 1123 may have at least three inclination surfaces inclined in different directions relative to each other. The rotation shaft ball 3421 may form a contact point with each inclination surface. Accordingly, the rotation shaft ball 3421 may be in contact with at least three points in each of the fifth accommodating groove 3323 and the sixth accommodating groove 1123.

Since the rotation shaft ball 3421 is positionally constrained in three directions in a state of being inserted between the fifth accommodating groove 3323 and the sixth accommodating groove 1123, the rotation shaft ball 3421 may be rotated in place by a driving force generated by the second driver 3330.

Additionally, the rotation carrier 3300 and the housing 1100 may be provided with guide grooves (hereinafter, a first guide groove 3324 and a second guide groove 1124) into which the plurality of guide balls 3422 are inserted. The first guide groove 3324 and the second guide groove 1124 may face each other in the second axis (Y-axis) direction.

The first guide groove 3324 and the second guide groove 1124 may extend in a rotation direction about the second axis (Y-axis) as a rotation axis. The plurality of guide balls 3422 may guide the rotation of the rotation carrier 3300 by rolling in an extension direction of the guide groove in a state in which the guide balls 3422 are inserted between the first guide groove 3324 and the second guide groove 1124.

The first guide groove 3324 and the second guide groove 1124 may be provided in a number corresponding to the number of the plurality of guide balls 3422.

Each of the plurality of guide balls 3422 may come into contact with the first guide groove 3324 and the second guide groove 1124 at one or more points.

The rotation carrier 3300 may be supported by the housing 1100 with the second ball member 3420 interposed therebetween. For example, the rotation carrier 3300 may be supported by the housing 1100 by an attractive force generated by a pair of magnetic bodies 3331 and 3334.

For example, the pair of magnetic bodies 3331 and 3334 may be the second driving magnet 3331 disposed on the rotation carrier 3300 and the second yoke 3334 disposed on portion of the main board 6000 disposed on the bottom surface of the housing 1100.

The pair of magnetic bodies 3331 and 3334 may generate an attractive force in a direction in which the magnetic bodies 3331 and 3334 face each other. Accordingly, the rotation carrier 3300 may be pressed against the second ball member 3420 and the housing 1100 in the second axis (Y-axis) direction by the attractive force. An action point of the attractive force generated by the pair of magnetic bodies 3331 and 3334 may be located inside a support region defined by lines connecting the rotation shaft ball 3421 and the guide balls 3422 of the second ball member 3420 to each other.

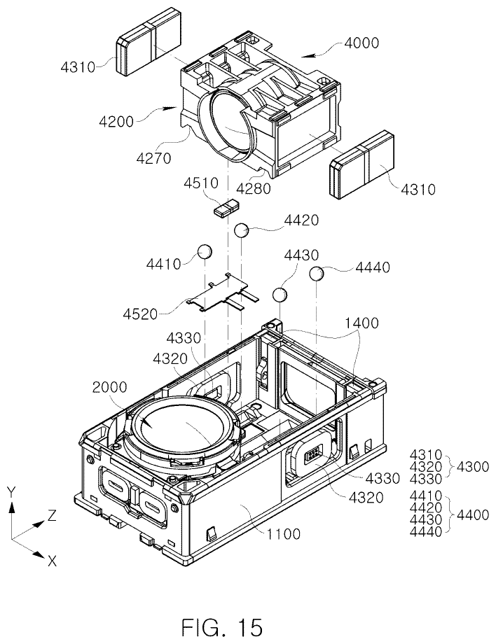

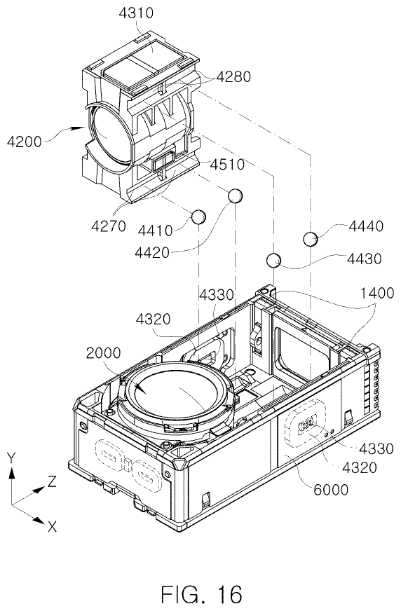

FIGS. 15 and 16 are exploded perspective views of a second lens module of the camera module of FIGS. 1 to 3.

Referring to FIGS. 15 and 16, the second lens module 4000 of the camera module of FIGS. 1 to 3 may include a second lens holder 4200 in which one or more lenses are mounted, and a third driver 4300 generating a driving force to move the second lens holder 4200.

One or more lenses may be mounted in the second lens holder 4200 in the second optical axis direction. The second lens holder 4200 may be provided to be movable in the second optical axis direction (Z-direction) between the reflection module 3000 and the image sensor module 5000.

Although not illustrated in the drawing, the second lens module 4000 may include a plurality of second lens holders 4200 in which the one or more lenses are mounted, and may be provided to be independently movable, or some of the second lens holders 4200 may be fixed to the housing 1100.

The third driver 4300 may include a third driving magnet 4310, a third driving coil 4320, and a third position sensor 4330.

The second lens holder 4200 may be moved in the second optical axis direction by an electromagnetic interaction between the third driving magnet 4310 and the third driving coil 4320.

The third driving magnet 4310 and the third driving coil 4320 may be disposed to face each other. For example, the third driving magnet 4310 may be disposed on one side surface or two side surfaces of the second lens holder 4200, and the third driving coil 4320 may be disposed on one side surface or two side surfaces of the housing 1100 facing the one side surface or the two side surfaces of the second lens holder 4200 on which the third driving magnet 4310 is disposed.

The third driving magnet 4310 may be magnetized so that a surface thereof facing the third driving coil 4320 includes an N pole (or an S pole), a neutral region, and an S pole (or an N pole) disposed in sequential order in the second optical axis direction (Z-direction), which is a movement direction of the second lens holder 4200.

The third position sensor 4330 may also be disposed on the housing 1100 to face the third driving magnet 4310. For example, the third position sensor 4330 may be a magnetic sensor sensing a change in a magnetic flux of the third driving magnet 4310 to sense the position of the lens second holder 4200. In order to efficiently sense the change in the magnetic flux, the third position sensor 4330 may face the neutral region of the third driving magnet 4310.

The third driving coil 4320 and the third position sensor 4330 may be attached to the main board 6000 and may be disposed on one side surface or two side surfaces of the housing 1100.

The third driving coil 4320 and the third position sensor 4330 may be disposed on one surface of the main board 6000, and the third position sensor 4330 may be disposed inside or outside of the third driving coil 4320 on the one surface of the main board 6000.

A through-hole may be provided in one side surface or two side surfaces of the housing 1100, and the main board 6000 may be disposed on the housing 1100 so that the one surface of the main board on which the third driving coil 4320 and the third position sensor 4330 are disposed is exposed to the internal space of the housing 1100 through the through-hole. Accordingly, the third driving magnet 4310 may directly face the third driving coil 4320 and the third position sensor 4330 through the through-hole.

A third yoke (not illustrated) may be disposed on the main board 6000. The third yoke may be disposed on an opposite surface of the main board 6000 from the one surface of the main board 6000 on which the third driving coil 4320 and the third position sensor 4330 are disposed to block leakage of a magnetic flux generated by the third driving magnet 4310.

A plurality of ball members (hereinafter a third ball member 4400) reducing friction and assisting movement of the second lens holder 4200 in the second optical axis direction may be disposed between the second lens holder 4200 and the housing 1100. The third ball member 4400 may include three or more ball members.

Referring to FIGS. 15 and 16, the third ball member 4400 includes four ball members 4410, 4420, 4430, and 4440 disposed between the second lens holder 4200 and the housing 1100. The four ball members 4410, 4420, 4430, and 4440 may include two pairs of ball members spaced apart from each other in the second optical axis direction. Among the two pairs of ball members, one pair of ball members 4410 and 4420 may support one side of the second lens holder 4200, and the other pair of ball members 4430 and 4440 may support the other side of the second lens holder 4200.

The four ball members 4410, 4420, 4430, and 4440 may be inserted between guide grooves provided in the second lens holder 4200 and guide grooves provided in the housing 1100.

The guide grooves provided in the second lens holder 4200 and the housing 1100 may be formed to extend in the second optical axis (Z-axis) direction. The four ball members 4410, 4420, 4430, and 4440 may guide the movement of the second lens holder 4200 by rolling in an extension direction of the guide grooves while in a state of being inserted between the guide grooves.

The second lens holder 4200 may be provided with two guide grooves 4270 accommodating the ball members 4410 and 4420, and two guide grooves 4280 accommodating the ball members 4430 and 4440.

For example, the guide grooves 4270 provided on one side of the second lens holder 4200 and the guide grooves 4280 provided on the other side of the second lens holder 4200 may have different cross-sectional shapes. Accordingly, a pair of ball members 4410 and 4420 supporting one side of the second lens holder 4200 may come into two-point contact with the guide grooves 4270, and a pair of ball members 4430 and 4440 supporting the other side of the second lens holder 4200 may come into one-point contact with the guide grooves 4280.

Similarly, the housing 1100 may be provided with four guide grooves 1170 and 1180 accommodating the four ball members 4410, 4420, 4430, and 4440. The above description of the four guide grooves 4270 and 4280 provided in the second lens holder 4200 may be equally applied to the four guide grooves 1170 and 1180 provided in the housing 1100.

In another embodiment, the number of guide grooves provided in the second lens holder 4200 and the housing 1100 may be changed. The number of guide grooves provided in the second lens holder 4200 and the housing 1100 does not necessarily correspond to the number of the plurality of ball members disposed between the second lens holder 4200 and the housing 1100.

The second lens holder 4200 may be supported by the housing 1100 with a plurality of ball members 4400 interposed therebetween. For example, the second lens holder 4200 may be supported by the housing 1100 by an attractive force generated by a pair of magnetic bodies 4510 and 4520.

The pair of magnetic bodies 4510 and 4520 may be disposed to face each other in the second lens holder 4200 and the housing 1100. For example, the pair of magnetic bodies 4510 and 4520 may be a pulling magnet and a pulling yoke.

The pair of magnetic bodies 4510 and 4520 may generate an attractive force in a direction in which the pair of magnetic bodies 4510 and 4520 face each other. Accordingly, the second lens holder 4200 and the third ball member 4400 may be pressed against the housing 1100 in a direction perpendicular to the second optical axis (a Y-axis direction based on the drawing). An action point of the attractive force generated by the pair of magnetic bodies 4510 and 4520 may be located inside a support region defined by lines connecting the four ball members 4410, 4420, 4430, and 4440 to each other.

A stopper 1400 may be disposed on the housing 1100 to limit a range of movement of the second lens holder 4200 and absorb shocks and noise generated during a collision between the second lens holder 4200 and the housing 1100.

The stopper 1400 may be disposed on the housing 1100 to face the second lens holder 4200 in the second optical axis direction. The stopper 1400 may be disposed between the second lens holder 4200 and the reflection module 3000 and between the second lens holder 4200 and the image sensor module 5000.

The stopper 1400 may be provided with a damper protruding toward the second lens holder 4200. The second lens holder 4200 may be in contact with the damper in a state in which the second lens holder 4200 is moved a maximum distance in the second optical axis direction (±Z-direction). Accordingly, the damper may be made of a material capable of absorbing shocks and noise generated during a collision between the second lens holder 4200 and the housing 1100.

While this disclosure includes specific examples, it will be apparent after an understanding of the disclosure of this application that various changes in form and detail may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A reflection module comprising:
a housing;
a rotation carrier disposed in the housing;
a reflection member holder supported on the rotation carrier to be rotatable about a first axis;
a reflection member disposed on the reflection member holder; and
a first ball member contacting the rotation carrier and the reflection member holder and forming the first axis,
wherein the first ball member comprises a plurality of ball members spaced apart from each other in a direction of the first axis, and
a plurality of contact points formed by the plurality of ball members with the reflection member holder and a plurality of contact points formed by the plurality of ball members with the rotation carrier are disposed at different positions in a direction of a second axis perpendicular to the first axis.

2. The reflection module of claim 1, wherein the reflection member holder comprises a first accommodating groove and a second accommodating groove spaced apart from each other in the first axis direction and accommodating a portion of the first ball member, and
the rotation carrier comprises a third accommodating groove facing the first accommodating groove and a fourth accommodating groove facing the second accommodating groove and accommodating another portion of the first ball member.

3. The reflection module of claim 2, wherein the plurality of ball members of the first ball member comprise a main ball member disposed between the first accommodating groove and the third accommodating groove, and a sub-ball member disposed between the second accommodating groove and the fourth accommodating groove, and
a number of contact points formed by the main ball member with the first accommodating groove and the third accommodating groove is greater than a number of contact points formed by the sub-ball member with the second accommodating groove and the fourth accommodating groove.

4. The reflection module of claim 3, wherein the main ball member is in three-point contact with each of the first accommodating groove and the third accommodating groove, and
the sub-ball member is in two-point contact with one of the second accommodating groove and the fourth accommodating groove, and is in three-point contact with another one of the second accommodating groove and the fourth accommodating groove.

5. The reflection module of claim 2, wherein each of the first accommodating groove, the second accommodating groove, the third accommodating groove, and the fourth accommodating groove comprises a plurality of inclination surfaces inclined in different directions relative to each other, and
the first ball member is in contact with some of the inclination surfaces.

6. The reflection module of claim 5, wherein one of the first accommodating groove and the second accommodating groove comprises three inclination surfaces in contact with the first ball member, and another one of the first accommodating groove and the second accommodating groove comprises two inclination surfaces in contact with the first ball member.

7. The reflection module of claim 5, wherein each of the third accommodating groove and the fourth accommodating groove comprises three inclination surfaces in contact with the first ball member, and
the three inclination surfaces of the third accommodating groove are inclined in different directions relative to the three inclination surfaces of the fourth accommodating groove.

8. The reflection module of claim 5, wherein the first ball member forms three contact points with portions of the first accommodating groove, the third accommodating groove, and the fourth accommodating groove, and
a virtual triangle formed by connecting the three contact points is symmetrical with respect to a first line extending in a direction parallel to the first axis and asymmetrical with respect to a second line extending in a direction parallel to the second axis.

9. The reflection module of claim 1, wherein the reflection member holder is supported on the rotation carrier in a direction of a third axis perpendicular to both the first axis and the second axis perpendicular to the first axis.

10. The reflection module of claim 9, further comprising:
a first magnetic body disposed on the reflection member holder; and
a second magnetic body disposed on the rotation carrier and facing the first magnetic body in the third axis direction.

11. The reflection module of claim 1, wherein the rotation carrier is disposed in the housing to be rotatable about the second axis perpendicular to the first axis, and
the reflection member holder is rotatable about the second axis together with the rotation carrier.

12. A camera module comprising:
the reflection module of claim 1; and
a lens module comprising a plurality of lenses configured to refract light passing through the reflection module.

13. A reflection module comprising:
a housing;
a rotation carrier disposed in the housing;
a reflection member holder supported on the rotation carrier to be rotatable about a first axis;
a reflection member disposed on the reflection member holder; and
a first ball member disposed between the rotation carrier and the reflection member holder and forming the first axis,
wherein the first ball member forms three contact points with either one or both of the rotation carrier and the reflection member holder, and all three sides of a virtual triangle defined by lines connecting the three contact points to each other have lengths in directions oblique to a direction parallel to the first axis.

14. The reflection module of claim 13, wherein the first ball member comprises a main ball member forming three contact points with each of the reflection member holder and the rotation carrier, and a sub-ball member forming three contact points with either one of the reflection member holder and the rotation carrier, and
the main ball member and the sub-ball member are spaced apart from each other in a direction of the first axis.

15. The reflection module of claim 13, wherein the three contact points formed by the first ball member with the reflection member holder and the rotation carrier are disposed at different positions in a direction of a second axis perpendicular to the first axis.

16. The reflection module of claim 13, wherein the reflection member holder is supported on the rotation carrier in a direction of a third axis perpendicular to both the first axis and a second axis perpendicular to the first axis, with the first ball member being interposed between the reflection member holder and the rotation carrier.
